(19) United States
(12) Patent Application Publication
(10) Pub. No.: US 2013/0054691 A1
(43) Pub. Date: Feb. 28, 2013

(54) FLEXIBLE RULE BASED MULTI-PROTOCOL PEER-TO-PEER CACHING

(71) Applicants: Seraphin B. Calo, Cortlandt Manor, NY (US); Robert B. Nicholson, Southsea (GB); Maroun Touma, Redding, CT (US); Dinesh C. Verma, New Castle, NY (US)

(72) Inventors: Seraphin B. Calo, Cortlandt Manor, NY (US); Robert B. Nicholson, Southsea (GB); Maroun Touma, Redding, CT (US); Dinesh C. Verma, New Castle, NY (US)

(73) Assignee: INTERNATIONAL BUSINESS MACHINES CORPORATION, Armonk, NY (US)

(21) Appl. No.: 13/221,353

(22) Filed: Aug. 30, 2011

(51) Int. Cl. G06F 15/16

(52) U.S. Cl. 709/204

(57) ABSTRACT

Flexible rule based multi-protocol peer-to-peer caching in a wireless environment. A request is received from a requestor for a file from one of a plurality of peer-to-peer networks. The peer-to-peer network the request is directed to is determined in response to receiving the request. Using a generic rule structure, the file that is requested from the peer-to-peer network is identified. The generic rule structure is compatible with all of the plurality of peer-to-peer networks. If the file is stored in a cache it is retrieved from the cache and is transmitted to the requestor.

### BACKGROUND

This invention relates generally to processing within a computing environment, and more particularly to flexible rule based, multi-protocol peer-to-peer caching in a wireless environment.

Peer-to-peer (P2P) file sharing allows a group of people to share one or more files with each other. Typically, P2P networks operate by allowing files to be transferred in pieces, often from multiple sources at once, and then aggregated and recombined at the requestor's computer. The received file segments may then be used to supply subsequent requestors with files. A number of such P2P file-sharing networks exist, each supporting their own architecture and file sets. The explosion of P2P file sharing has put a strain on the ability of the Internet backbone to handle the millions of users that are connecting to P2P networks everyday. By some estimates, P2P network traffic accounts for as much as 70% of all Internet service provider (ISP) traffic. In the US, over ⅓ of America's Internet users (roughly 75 million users) are connected to one or more of the multitudes of P2P networks.

The distributed architecture of the P2P network, which is composed of connected nodes that make a portion of their resources (i.e., files) directly available to other network participants, without the need for central coordination (e.g., dedicated servers), makes such a network hard to control. This distributed network, however, is attractive to mobile users who want to exploit the “unlimited storage” capacity of the network.

P2P traffic is estimated to be 60% videos, 13% songs and 37% all other files including software and e-books. The growth in mobile wireless technology, and the availability of smart devices capable of playing video, music, e-books, games and other applications, is expected to further increase the infrastructure strain for both traditional ISPs and for wireless carriers.

### BRIEF SUMMARY

An embodiment includes a computer implemented method for executing flexible rule based multi-protocol peer-to-peer caching. The method includes receiving a request from a requestor for a file from one of a plurality of peer-to-peer networks. The method additionally includes determining which peer-to-peer network the request is directed to in response to receiving the request, and identifying, using a generic rule structure, the file that is requested from the peer-to-peer network. The generic rule structure is compatible with all of the plurality of peer-to-peer networks. The method further includes determining if the file is stored in a cache and retrieving the file from the cache if the file is stored in the cache. The method additionally includes transmitting the file to the requestor.

An additional embodiment includes a system for executing flexible rule based multi-protocol peer-to-peer caching. The system comprises a peer-to-peer proxy computer configured to perform a method. The method includes receiving a request from a requestor for a file from one of a plurality of peer-to-peer networks. The method additionally includes determining which peer-to-peer network the request is directed to in response to receiving the request, and identifying, using a generic rule structure, the file that is requested from the peer-to-peer network. The generic rule structure is compatible with all of the plurality of peer-to-peer networks. The method further includes determining if the file is stored in a cache and retrieving the file from the cache if the file is stored in the cache. The method additionally includes transmitting the file to the requestor.

A further embodiment includes a computer program product for flexible rule based multi-protocol peer-to-peer caching. The computer program product includes a tangible storage medium readable by a processing circuit and storing instructions for execution by the processing circuit for performing a method. The method includes receiving a request from a requestor for a file from one of a plurality of peer-to-peer networks. The method additionally includes determining which peer-to-peer network the request is directed to in response to receiving the request, and identifying, using a generic rule structure, the file that is requested from the peer-to-peer network. The generic rule structure is compatible with all of the plurality of peer-to-peer networks. The method further includes determining if the file is stored in a cache and retrieving the file from the cache if the file is stored in the cache. The method additionally includes transmitting the file to the requestor.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a schematic diagram of a flexible rule based multi-protocol peer-to-peer caching system that may be implemented by an embodiment;

FIG. 2 depicts a schematic diagram of a rule based P2P proxy caching system in an embodiment;

FIG. 3 depicts a schematic diagram of a P2P proxy in an embodiment;

FIG. 4 depicts a state diagram that may be implemented by a P2P proxy in an embodiment;

FIG. 5 depicts a flow diagram of the processing of a client request by a P2P proxy in an embodiment; and

FIG. 6 depicts a flow diagram of the intercepting a file in a P2P response by a P2P proxy in an embodiment.

### DETAILED DESCRIPTION

An embodiment of the present invention provides for flexible rule based multi-protocol peer-to-peer caching.

In an embodiment, a P2P caching proxy is established that intercepts requests from various P2P networks for files. The P2P caching proxy includes plug-ins to provide rule based processing of P2P file requests for each of the various P2P networks. In an embodiment, the rules are mapped to states and transitions that are common across all of the various P2P networks. When a request for a file is received, the P2P caching proxy uses the rules to support the file request locally, from a cache of such files, and thereby eliminates the need to propagate the request to the Internet backbone. In an embodiment, the file request can be served from any of the P2P networks rather than the traditional requirement that each client support only a single network. In an embodiment, additional P2P networks are included by adding rules to support the requirements of the additional P2P networks.

In an embodiment, ISPs and wireless carriers may reduce networking traffic associated with P2P file sharing by setting up a P2P caching proxy within the ISP, or the radio access network for wireless carriers, that is capable of serving local users within a given geography with content made available by other nodes on a given P2P network operating on the Internet, or other network supporting file sharing. In a P2P network nodes, also referred to as peers, are other clients that serve files to requestors. Therefore, a single node can be both a client requesting files and resources from a network, and a peer that serves files or file fragments over the network to requestors.

In an embodiment, a caching proxy is implemented as a generic file transfer engine with protocol specific extensions that support a large number of current and future protocols for file sharing, and that operate as a transparent proxy that is capable of intercepting protocol specific requests originating from the mobile device and satisfying the requests.

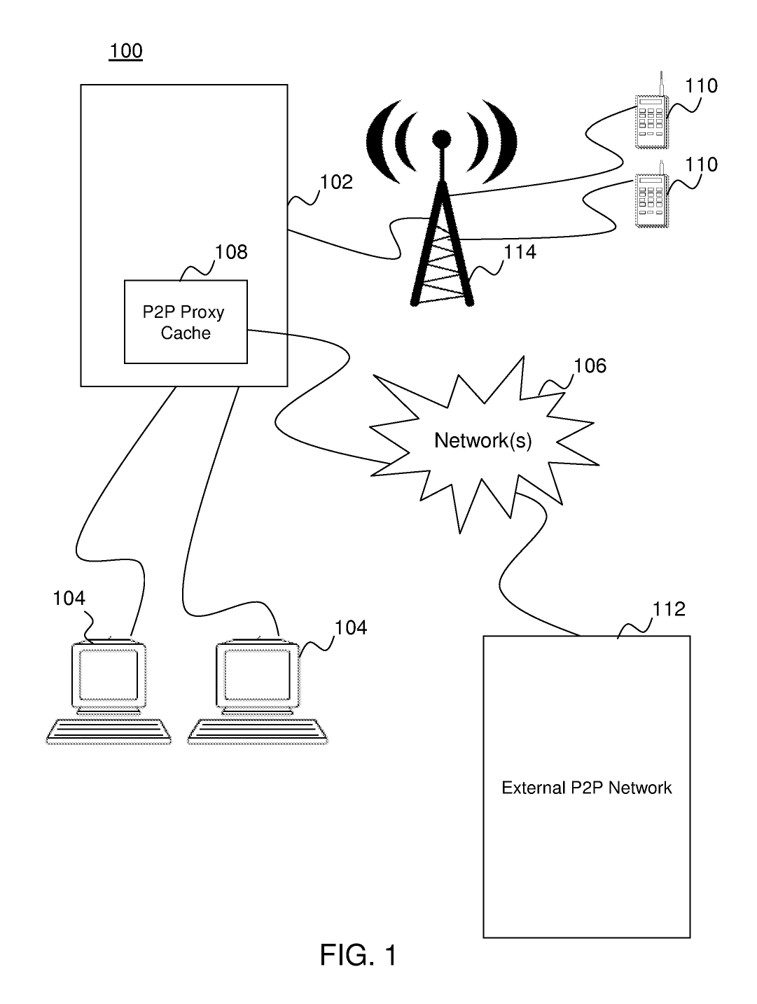

Turning now to FIG. 1, a system 100 for implementing flexible rule based multi-protocol peer-to-peer caching will now be described. In an embodiment, the system 100 includes a host system computer 102 executing computer instructions for flexible rule based multi-protocol peer-to-peer caching. The host system computer 102 may operate in any type of environment that is capable of executing a software application. The host system computer 102 may comprise a high-speed computer-processing device, such as a mainframe computer, to manage the volume of operations governed by an entity for which the flexible rule based multi-protocol peer-to-peer caching system is executing. In an embodiment, the host system computer 102 is part of an enterprise (e.g., a commercial business) that implements the flexible rule based multi-protocol peer-to-peer caching. In an additional embodiment, the host system computer 102 is a hardware or software component executing directly at a radio access network, such as the radio access network 114.

In an embodiment, the system 100 depicted in FIG. 1 includes one or more client systems 104 through which users at one or more geographic locations may contact the host system computer 102. The client systems 104 are coupled to the host system computer 102. Each client system 104 may be implemented using a general-purpose computer executing a computer program for carrying out the processes described herein. The client systems 104 may be personal computers (e.g., a laptop, a personal digital assistant, a mobile device) or host attached terminals. If the client systems 104 are personal computers, the processing described herein may be shared by a client system 104 and the host system computer 102 (e.g., by providing an applet to the client system 104). Client systems 104 may be operated by authorized users (e.g., programmers) of the flexible rule based multi-protocol peer-to-peer caching system described herein.

In an embodiment, the system 100 includes one or more mobile telephone handsets 110. In an embodiment, the one or more mobile telephone handsets 110 are capable of Internet connectivity, and the execution of software thereon. The one or more mobile telephone handsets 110 connect to the radio access network 114. The one or more mobile telephone handsets 110 are mobile, and in an embodiment, the one or more mobile telephone handsets 110 move between one or more radio access networks 114 as is known in the art. In alternate embodiments, the system 100 may include tablet computers, wirelessly connected laptops, and other wireless devices as are known in the art.

In an embodiment, the host system computer 102 includes a P2P proxy cache 108. In an embodiment, the P2P proxy cache 108 is a hardware device included in the host system computer 102. In an additional embodiment, the P2P proxy cache 108 is a hardware device included in the radio access network 114. In yet another embodiment, the P2P proxy cache is software executing on the host system computer 102/and or the radio access network 114. In an embodiment, the P2P proxy cache 108 is connected to an external P2P network 112. In an embodiment, the external P2P network 112 includes one or more computers supporting P2P networks and connected to the network as is known in the art. In yet another embodiment, the external P2P network includes any number of P2P networks executing across multiple P2P client computers over a network.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. In an embodiment, the P2P proxy cache 108, client system 104, and/or the radio access network 114 may be coupled to the host system computer 102 through multiple networks (e.g., intranet and Internet) so that they are not all coupled to the host system computer 102 through the same network. One or more of the P2P proxy cache 108, client system 104, the radio access network 114 and the host system computer 102 may be connected to the networks 106 in a wireless fashion, or in a wired connection over, for example, a fiber optic, or copper wire network. In one embodiment, the networks 106 include an intranet and one or more client systems 104 executing a user interface application (e.g., a web browser) to contact the host system computer 102 through the networks 106. In another embodiment, the client system 104 is connected directly (i.e., not through the networks 106) to the host system computer 102 and the host system computer 102 contains memory for storing data in support of flexible rule based multi-protocol peer-to-peer caching. Alternatively, a separate storage device may be implemented for this purpose.

The host system computer 102 depicted in the system of FIG. 1 may be implemented using one or more servers operating in response to a computer program stored in a storage medium accessible by the server. The host system computer 102 may operate as a network server (e.g., a web server) to communicate with the P2P proxy cache 108, client system 104, and the radio access network 114. The host system computer 102 may also operate as an application server. The host system computer 102 executes one or more computer programs to provide the flexible rule based multi-protocol peer-to-peer caching, such as the P2P proxy cache 108. As indicated above, processing may be shared by the client systems 104 and the host system computer 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

It will be understood that the flexible rule based multi-protocol peer-to-peer caching system described in FIG. 1 may be implemented in hardware, software executing on a general-purpose computer, or a combination thereof.

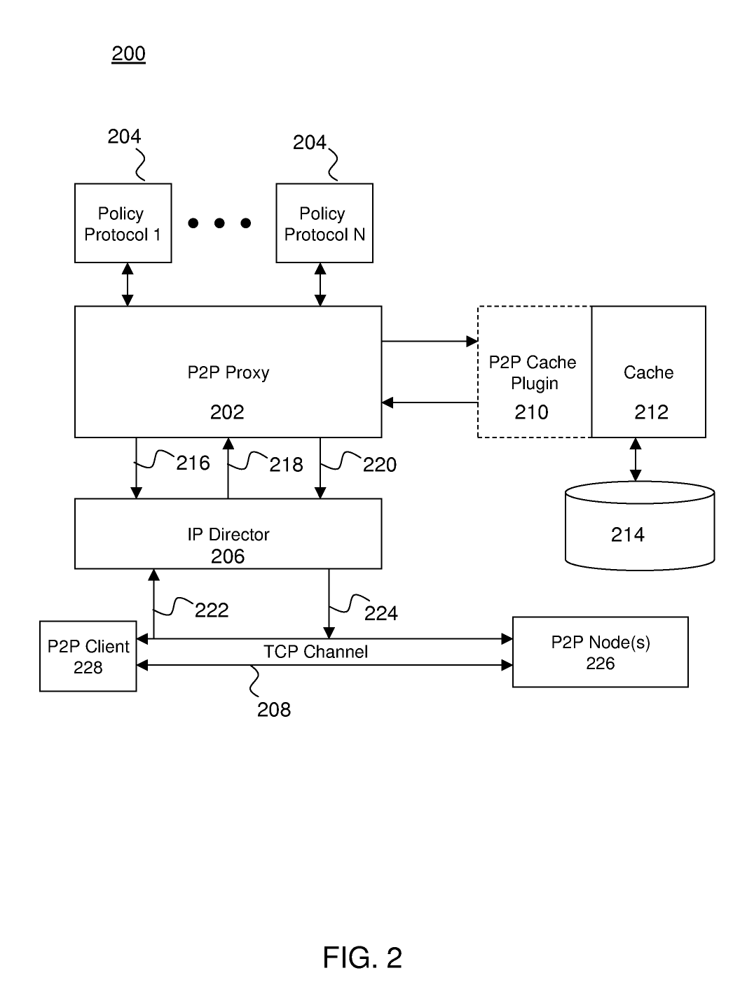

FIG. 2 depicts a schematic diagram of a rule based P2P proxy caching system in an embodiment. In an embodiment, the rule based P2P proxy caching system 200 of FIG. 2 executes in a P2P proxy cache, such as the P2P proxy cache of FIG. 1. The rule based P2P proxy caching system includes a P2P proxy module 202. The P2P proxy module 202 coordinates the transactions, and file requests coming from P2P clients and manages the files, and file fragments coming from P2P nodes. File fragments are portions of files that are transmitted by some P2P networks. Large files are broken into small fragments and are sent to a requestor in pieces from one or more peer nodes. The file fragments are then put together (i.e. reconstituted) into the original file at the client system. In an embodiment, the P2P proxy module 202 additionally coordinates rule interpretation and processing based on each of the P2P networks. In an embodiment, the P2P proxy facilitates the storage and retrieval of data in a cache 212.

In an embodiment, the rule based proxy caching system 200 includes a P2P cache plug-in 210. The P2P cache plug-in 210 is in communication with the P2P proxy 202, and receives requests to store and fetch files and file fragments from the cache 212. In an embodiment, the P2P cache plug-in 210 is in communication with the cache 212 and facilitates storage and retrieval of files, and portions of files. P2P networks generally transmit files in several small pieces, from one or more nodes in the P2P network. In an embodiment, the P2P cache plug-in 210 aggregates file portions until a full file is received, and then stores the entire file in the cache 212. In an alternate embodiment, the P2P cache plug-in 210 stores the pieces of the files in the cache directly and aggregates the pieces into a single file in response to a fetch request from the P2P proxy 202. In yet another embodiment, the P2P cache plug-in 210 stores the pieces in the cache 212, and when the cache determines that a complete file has been received, it fetches the pieces from the cache, assembles the complete file, and stores it in the cache 212 in its entirety. In an embodiment, the P2P proxy 202 manages the cache 212 directly, and no P2P cache plug-in 210 is implemented. In yet another embodiment, the cache 212 is capable of managing file fragments and files directly.

In an embodiment, the cache 212 is in communication with a storage device 214. In an embodiment, the storage device 214 includes a data repository that includes files and/or file fragments, as well as other data/information. In an embodiment, the storage device 214 is logically addressable as a consolidated data source across a distributed environment. Information stored in the storage device 214 is retrieved and manipulated via the cache 212. It will be understood by those of ordinary skill in the art that the storage device 214 may also comprise other structures, such as an XML file on the file system or distributed over a network (e.g., one of networks 106 of FIG. 1), or from a data stream from another server located on a network 106.

In an embodiment the rule based P2P proxy caching system 200 includes one or more protocol policies 204 in communication with the P2P proxy 202. Each of the one or more protocol policies 204 represents a different P2P network, and includes a mapping between generic rules for transitions between states and the specific rules for that are particular to the P2P network that it represents. The generic rules correspond to a generic rule structure in the P2P proxy 202 that represents a plurality of states and transitions between the states as will be described in more detail below. In an embodiment, the rules are policies that are described in a policy modeling language, such as Simple Policy Language (SPL). In other embodiments, the rules and policies are defined using other methods, configuration files and/or languages, as is known in the art.

In an embodiment, the protocol policy includes all the rule based information required to manage the transfer of files to and from a P2P network. As new P2P networks are established, and/or when users desire adding support for existing P2P networks, the support is added by adding a new protocol policy with rules that support the new P2P network.

In an embodiment, the rule based proxy caching system 200 additionally includes an IP director module 206 in communication with the P2P proxy 202. In an embodiment, the P2P proxy 202 registers each P2P network that it supports as defined by the one or more protocol policies 204, with the IP director module 206 via a registration function 216. In an embodiment, the registration function establishes, with the IP director module 206, the characteristics of a data packet that is being sent to, or received from a particular P2P node. In an embodiment, the addition or modification of a protocol policy 204 triggers the registration function to register that a P2P network associated with the new or modified protocol policy 204 has been added. In an embodiment, the registration function 216 is used to deregister a P2P network from the IP director when, for example, a protocol policy 204 is removed from the P2P proxy 202. In an embodiment, the IP director module 206 forwards requests from a client to one of the one or more P2P networks that have been registered with the IP director module 206 to the P2P proxy 202 which then process the request by retrieving the requested file from the cache 212 as will be described in more detail below. In an embodiment, the IP director module 206 forwards responses from a node in one of the one or more P2P networks that have been registered with the IP director module 206 to the P2P proxy 202 which then caches the data in the cache 212 as will be described in more detail below.

In an embodiment, the IP director module 206 forwards requests that are sent from a P2P client 228 and are meant for one of the one or more P2P Nodes 226 of the one or more P2P networks that have been registered with the IP director module 206 to the P2P proxy 202 using a read function 218. The P2P proxy 202 then processes the request by retrieving the requested file from the cache 212 and returning the file via a write function 220 as will be described in more detail below. In an embodiment, the read function 218 also provides a facility to store files or pieces of files that are received from the P2P nodes 226 for requests from a P2P client 228 for files that the P2P proxy 202 does not currently have stored in the cache 212. The P2P proxy 202 then stores these files, or file fragments in the cache 212.

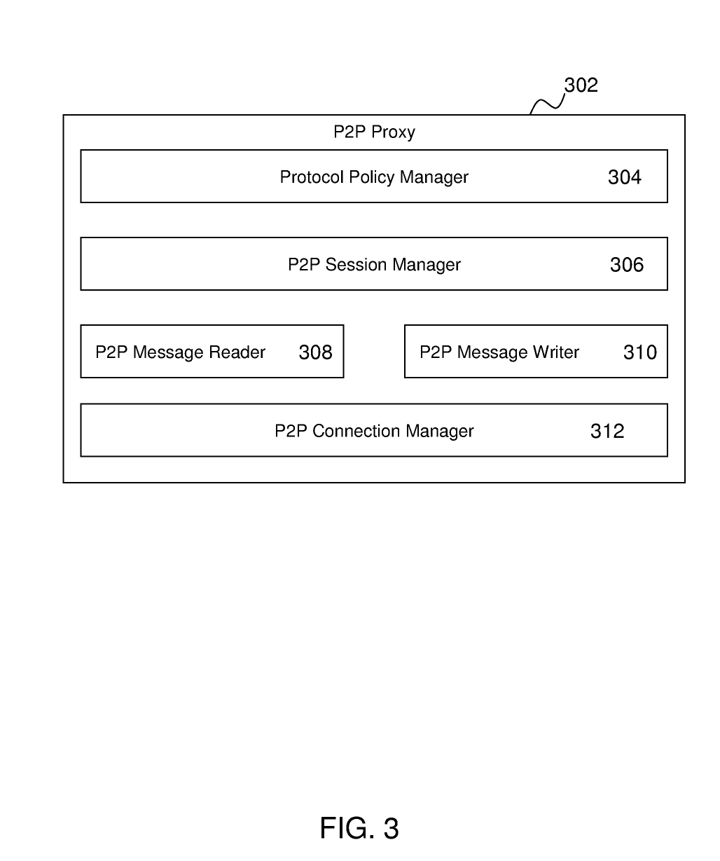

FIG. 3 depicts a schematic diagram of a P2P proxy 302 in an embodiment. In an embodiment, the P2P proxy 302 includes a protocol policy manager 304. The protocol policy manager 304 manages one or more protocol policies, such as the protocol policies 204 of FIG. 2. In an embodiment, the protocol policy manager 304 applies the various rules defined in the protocol policies 204 to the various stages to the P2P protocol transactions as will be described in more detail below. In an embodiment, the protocol policy manager 304 registers the various protocol policies 204 with an IP director, such as the IP director module 206 of FIG. 2. In an embodiment, the P2P proxy 302 includes a P2P session manager 306. The P2P session manager 306 manages P2P sessions according to the session requirements of each P2P protocol. In an embodiment, the session requirements are defined by the protocol policies 204 of FIG. 2. In an embodiment the P2P session manager 306 maintains connections between a P2P client and the one or more files that are being transmitted from a cache to the P2P client.

In an embodiment, the P2P proxy 302 includes a P2P message reader 308. In an embodiment, the P2P message reader 308 reads requests from one or more P2P clients for files and matches the requests to files in the cache. In an embodiment, the P2P message reader 308 determines if the requests are in the cache, and notifies the IP director module 206 of FIG. 2 to continue to direct the client requests for that file to the P2P proxy 302. In an embodiment, the P2P message reader 308 determines that the requested file is not in the cache, and directs the IP director module 206 to forward the message to its destination.

In an embodiment, the P2P proxy 302 includes a P2P message writer 310. The P2P message writer 310 receives files and/or file fragments from one or more P2P nodes, such as the P2P nodes 226 of FIG. 2, and stores the files or file fragments in the cache.

In an embodiment, the P2P proxy 302 includes a connection manager 312. The connection manager 312 maintains connections between the one or more P2P clients and the files and/or file fragments that they are downloading.

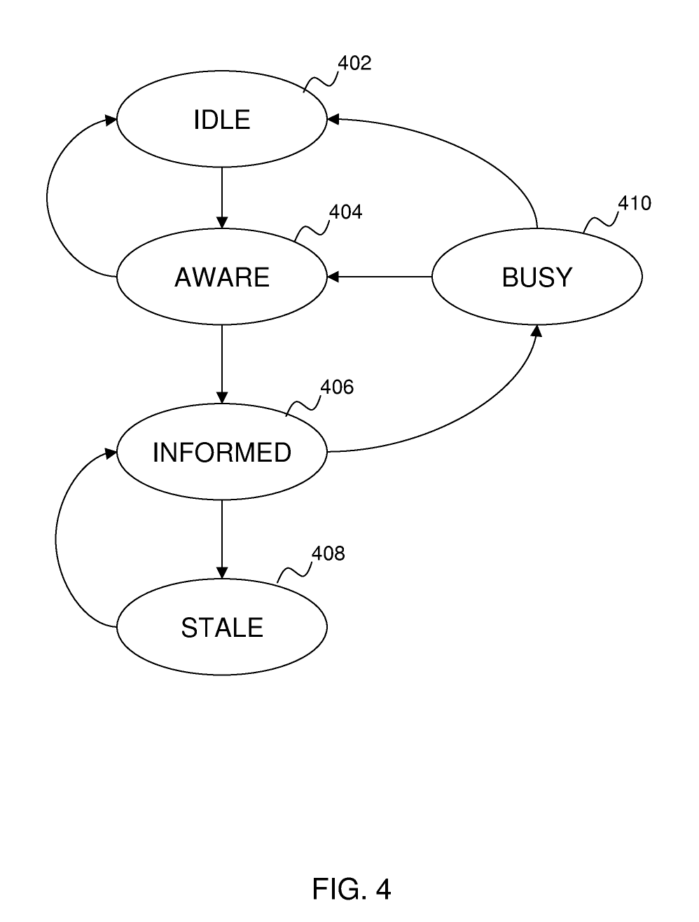

FIG. 4 depicts a state diagram that may be implemented by a P2P proxy in an embodiment. In an embodiment a P2P proxy, such as the P2P proxy 302 of FIG. 3, standardizes the flow of various P2P protocols using a standard state machine. FIG. 4 depicts the various states and transitions of a state machine in an embodiment. At state 402, the P2P network connection is idle. The idle state 402 occurs, for example, when no files are being transmitted from a client to or from the network. In an embodiment, the idle state 402 occurs even when the client is connected to a P2P network. In an embodiment, when a connection is established on another node (also referred to herein as a peer), in the network, and protocol negotiation has been completed, the state machine transitions to an aware state 404. In an embodiment, the aware state 404 is entered into when a client has established a connection to one or more peers on the P2P network, and has made any sharable files available to other peers on the network. In an embodiment, when a client, is in the aware state 404, the client may transmit files to other peers, but cannot receive files.

In an embodiment, once the aware state 404 has been reached, the client receives information about what files and/or resources are available on other peers in the network. In an embodiment, when the client receives this information from at least one other peer in the P2P network, the client transitions into the informed state 406. In an embodiment, when a client is in the informed state 406, the client may begin uploading files to the network and downloading files from the network. In an embodiment, once the client enters the informed state 406, the client may share what the client knows about file and resources availability with other peers on the network or act on their behalf.

In an embodiment, after some period of time, the client's list of available resources may differ from what is available over the P2P network because of new peers that have been added to a network, peers that have been removed from the network, and/or changes in the available files and/or resources of the network. In an embodiment, when this occurs the client transitions into a stale state 408. In an embodiment, when the client is in the stale state 408 it can no longer download new files, or file fragments, but is allowed to upload files to other peers in the network. In an embodiment, the client must perform a refresh of available peers, files, and resources available on the network in order to transition to the informed state 406.

In an embodiment, if a client can no longer accept connections from peers, then the client transitions to a busy state 410. In an embodiment, the busy state 410 occurs when a client has reached a bandwidth peak, and is no longer allowed to share or receive new files. In an additional embodiment, the client transitions to the busy state 410 when it is instructed to stop transmitting or receiving files. In an embodiment, the busy state 410 transitions to the idle state 402 if the client has been disconnected from the P2P network, and transitions to the aware state 404 when it has maintained a connection to at least one peer in the P2P network.

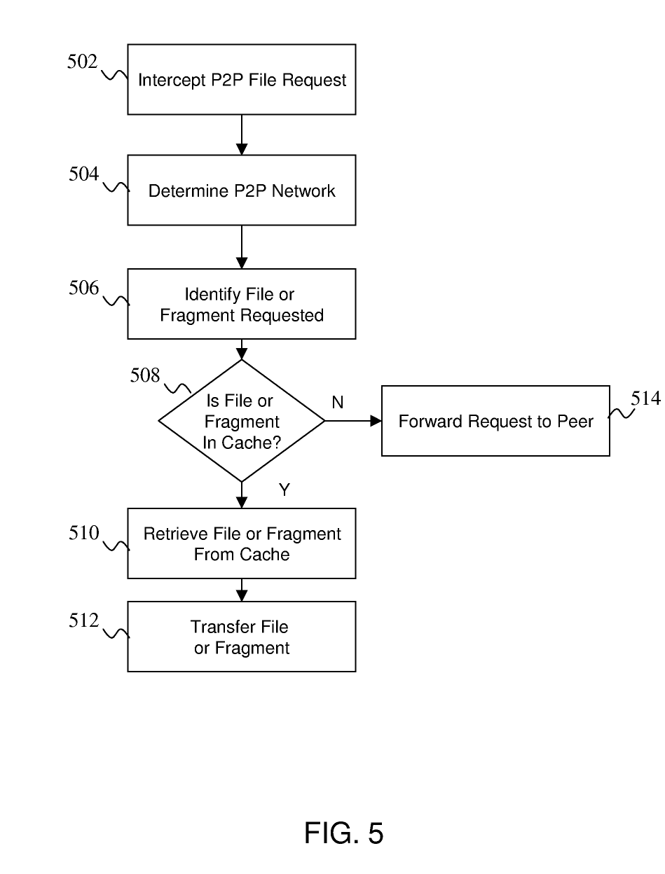

FIG. 5 depicts a flow diagram of the processing of a client request by a P2P proxy in an embodiment. In an embodiment, the process flow of FIG. 5 is executed by a P2P proxy such as the P2P proxy 302 of FIG. 3. At block 502, the P2P proxy 302 intercepts a request from a P2P client to a peer. In an embodiment, the IP director module 206 of FIG. 2 intercepts the request. At block 504 the P2P proxy 302 determines what P2P network the file request is directed to. In an embodiment, the P2P policy manager 304 uses the one or more protocol policies 204 to determine which P2P network the file request is directed to. At block 506 the P2P proxy 302 identifies what file or file fragment is requested. The P2P proxy 302 uses a the protocol policy manager 306 and the one or more policy profiles to determine a uniform resource identifier (URI) of the file based on the information that is provided in the file or fragment request. In an embodiment, the file name is used as the URI. In an alternate embodiment other file characteristics, such as the file size, file format, or a combination of other pieces of information are used to determine the URI of a file or fragment.

At block 508, once the URI has been determined, the cache, such as the cache 212 of FIG. 2 is search for the file. In an embodiment, if the request is for a file fragment, a P2P cache plug-in, such as the P2P cache plug-in 210 of FIG. 2 is used to retrieve the file fragment. In an embodiment, the P2P cache plug-in 210 stores file fragments outside of the cache 212 until it has acquired an entire file, and therefore, a request for a file fragment is returned directly from the P2P cache plug-in 210. In an embodiment, files and file fragments stored in a cache from a first P2P network are used to fulfill requests from a client of any other P2P network by matching the URI in a request from another network to the URI for the file or the file fragment stored in the cache from the first network.

If the file or file fragment is located in the cache, then at block 510, the file or file fragment is retrieved at block 510. At block 512 the file or file fragment is returned to the client and the request is never sent to peers in the P2P network.

Returning to block 508, if the request file or file fragment is not found in the cache, the request is forwarded to a peer in the P2P network to fulfill the request per the P2P networks standard procedure.

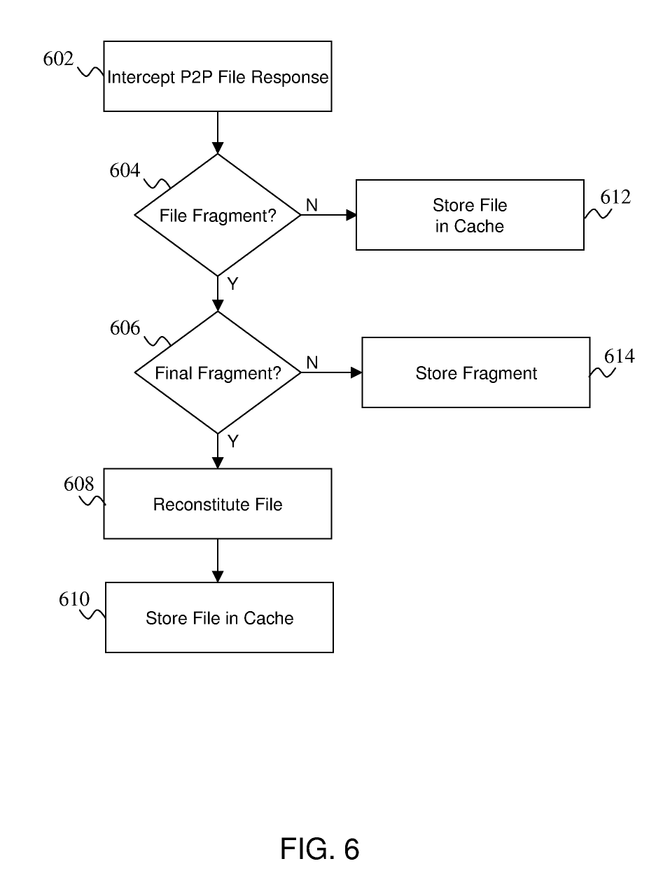

FIG. 6 depicts a flow diagram of the intercepting a file in a P2P response by a P2P proxy in an embodiment. In an embodiment the process flow of FIG. 6 is executed by a P2P proxy such as the P2P proxy 302 of FIG. 3. At block 602 the P2P proxy 302 intercepts a file response from a peer to a client. At block 604 it is determined if the response is a file or a file fragment. If the response is a whole file, then at block 612 the entire file is stored in the cache 212 of FIG. 2. If the response contains only a file fragment, then processing continues at block 606.

At block 606 it is determined if the fragment is the last fragment for the file, i.e. the fragment completes the file. If the fragment does not complete the file, then at block 614, the fragment is stored in the P2P cache proxy 210. Otherwise, if the file fragment is the final fragment, then at block 608, the P2P cache proxy reconstitutes the fragments into a file, and stores the file in the cache 212 at block 610. In an embodiment, the fragment is stored directly in the cache. In an embodiment, all files are passed to the P2P cache plug-in 210, which stores whole files in the cache, and only the fragments are stored locally. In an embodiment, once the P2P cache plug-in 210 stores the file fragment, any subsequent requests for the file fragment is processed by the P2P cache plug-in and returned to the requestor, even if the entire file is not yet available. In an embodiment, only a copy of the file is intercepted at block 602, and therefore the response is sent to the client in parallel without affecting the transmission speed of the file or file fragment.

Technical effects and benefits include the ability to cache files and file fragments that are transmitted to clients at the outer edges of the network thereby increasing performance while simultaneously decreasing congestion on the network. An additional benefit is the ability to server files from one P2P network to another P2P network without requiring reconfiguration. Yet another benefit is the ability to add additional P2P network protocol systems, without requiring programming and system restarts by plugging in protocol policies that are created for new protocols.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible storage medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for executing flexible rule based multi-protocol peer-to-peer caching, the method comprising:
receiving, by a computer, a request from a requestor for a file from one of a plurality of peer-to-peer networks;
determining, by the computer, which peer-to-peer network the request is directed to responsive to the receiving;
identifying, using a generic rule structure, the file that is requested from the peer-to-peer network, the generic rule structure compatible with all of the plurality of peer-to-peer networks;
determining if the file is stored in a cache responsive to the identifying;
retrieving the file from the cache responsive to determining that the file is stored in the cache; and
transmitting the file to the requestor responsive to retrieving the file from the cache.

2. The computer implemented method of claim 1, wherein the file is a file fragment or a collection of file fragments.

3. The computer implemented method of claim 1, wherein the generic rule structure comprises one or more protocol policies, the one or more protocol policies comprising a simple policy language, each of the one or more protocol policies comprising rules for processing the request for each of the plurality of peer-to-peer networks.

4. The computer implemented method of claim 3, wherein the one or more protocol policies further comprise rules for establishing and maintaining one or more connections between a node and a peer on the plurality of peer-to-peer networks.

5. The computer implemented method of claim 3, wherein a new peer-to-peer network is supported by adding a new protocol policy for the new peer-to-peer network.

6. The computer implemented method of claim 1, wherein the request is directed from the requestor to a peer on the peer-to-peer network, and the request is prevented from being sent to the peer in response to the determining.

7. The computer implemented method of claim 1, wherein the request is directed to a peer on the peer-to-peer network and is forwarded to the peer responsive to determining that the file is not in the cache, the method further comprising:
receiving the file from the peer;
copying the file before forwarding it to the requestor; and
storing a copy of the file in the cache.

8. A system for executing flexible rule based multi-protocol peer-to-peer caching, the system comprising:
a peer-to-peer proxy computer configured to perform:
receiving a request from a requestor for a file from one of a plurality of peer-to-peer networks;
determining which peer-to-peer network the request is directed to responsive to the receiving;
identifying, using a generic rule structure, the file that is requested from the peer-to-peer network, the generic rule structure compatible with all of the plurality of peer-to-peer networks;
determining if the file is stored in a cache responsive to the identifying;
retrieving the file from the cache responsive to determining that the file is stored in the cache; and
transmitting the file to the requestor responsive to retrieving the file from the cache.

9. The system of claim 8, wherein the file is a file fragment or a collection of file fragments.

10. The system of claim 8, wherein the generic rule structure comprises one or more protocol policies, the one or more protocol policies comprising a simple policy language, each of the one or more protocol policies comprising rules for processing the request for each of the plurality of peer-to-peer networks.

11. The system of claim 10, wherein the one or more protocol policies further comprise rules for establishing and maintaining one or more connections between a node and a peer on the plurality of peer-to-peer networks.

12. The system of claim 10, wherein a new peer-to-peer network is supported by adding a new protocol policy for the new peer-to-peer network.

13. The system of claim 8, wherein the request is directed from the requestor to a peer on the peer-to-peer network, and the request is prevented from being sent to the peer in response to the determining.

14. The system of claim 8, wherein the request is directed to a peer on the peer-to-peer network and is forwarded to the peer responsive to determining that the file is not in the cache, the method further comprising:
receiving the file from the peer;
copying the file before forwarding it to the requestor; and
storing a copy of the file in the cache.

15. A computer program product for flexible rule based multi-protocol peer-to-peer caching, the computer program product comprising:
a tangible storage medium readable by a processing circuit and storing instructions for execution by the processing circuit for performing a method comprising:
receiving a request from a requestor for a file from one of a plurality of peer-to-peer networks;
determining which peer-to-peer network the request is directed to responsive to the receiving;
identifying, using a generic rule structure, the file that is requested from the peer-to-peer network, the generic rule structure compatible with all of the plurality of peer-to-peer networks;
determining if the file is stored in a cache responsive to the identifying;
retrieving the file from the cache responsive to determining that the file is stored in the cache; and
transmitting the file to the requestor responsive to retrieving the file from the cache.

16. The computer program product of claim 15, wherein the file is a file fragment or a collection of file fragments.

17. The computer program product of claim 15, wherein the generic rule structure comprises one or more protocol policies, the one or more protocol policies comprising a simple policy language, each of the one or more protocol policies comprising rules for processing the request for each of the plurality of peer-to-peer networks.

18. The computer program product of claim 17, wherein the one or more protocol policies further comprise rules for establishing and maintaining one or more connections between a node and a peer on the plurality of peer-to-peer networks.

19. The computer program product of claim 17, wherein a new peer-to-peer network is supported by adding a new protocol policy for the new peer-to-peer network.

20. The computer program product of claim 15, wherein the request is directed from the requestor to a peer on the peer-to-peer network, and the request is prevented from being sent to the peer in response to the determining.

21. The computer program product of claim 15, wherein the request is directed to a peer on the peer-to-peer network and is forwarded to the peer responsive to determining that the file is not in the cache, the method further comprising:
receiving the file from the peer;
copying the file before forwarding it to the requestor; and
storing a copy of the file in the cache.
